(19) United States
(12) Patent Application Publication
(10) Pub. No.: US 2021/0370646 A1
(43) Pub. Date: Dec. 2, 2021

(54) GLAZING UNIT COMPRISING A CHEMICALLY TOUGHENED THIN GLASS SHEET

(71) Applicant: SAINT-GOBAIN GLASS FRANCE, COURBEVOIE (FR)

(72) Inventors: René GY, BONDY (FR); Vincent SAUVINET, GRENOBLE (FR); Malte Jonathan LINN, AACHEN (DE)

(21) Appl. No.: 17/262,570

(22) PCT Filed: Jul. 24, 2019
(86) PCT No.: PCT/EP2019/069898

§ 371 Date: Aug. 17, 2021

(30) Foreign Application Priority Data
Jul. 25, 2018 (FR) 1856926

(51) Int. Cl. B32B 17/10; C03C 3/087

(52) U.S. Cl. CPC B32B 17/10036; C03C 3/087; B32B 17/10119; B32B 17/10137; B32B 2255/205; B32B 2307/50; B32B 2307/732; B32B 2605/006; B32B 17/10807

(57) ABSTRACT

A laminated glazing unit includes a first sheet of soda-lime-silica mineral glass having a thickness e1 of between 1.5 mm and 2.5 mm, a second sheet of mineral glass and a lamination interlayer, the first and second mineral glass sheets being adhesively bonded together by the lamination interlayer. The second mineral glass sheet is a sheet of soda-lime-silica mineral glass having a thickness e2 of between 0.4 and 1.1 mm, the second sheet of soda-lime-silica mineral glass being chemically toughened. A surface compressive stress of the second sheet of soda-lime-silica mineral glass is between 350 MPa and 550 MPa and a ratio R=e1/e2² is at most 20 mm⁻¹.

### TECHNICAL FIELD

The invention relates to the field of laminated glazing units, in particular to laminated glazing units used as windshields, side windows or roof glazing units for vehicles.

### PRIOR ART

Laminated glazing units are glazing units in which at least two glass sheets are adhesively bonded to one another by means of a lamination interlayer.

A principal function of the lamination interlayer is to retain glass fragments in the event of breakage. Among other functions, the lamination interlayer can also, for example, confer on the laminated glazing unit break-in resistance, or else increase acoustic and thermal performance qualities.

The lamination interlayer generally comprises at least one polymer-based sheet, typically based on polyvinylbutyral, capable of softening during the lamination treatment and of adhering to the glass sheets.

Laminated glazing units are particularly used as windshields in land-based or airborne vehicles. They can also be used as side windows or roof glazing units. For these applications, they must in particular adhere to an increasing number of technical criteria in order to guarantee the safety of individuals and to adhere to certain environmental requirements in terms of energy saving.

These technical criteria can for example be mechanical criteria (impact strength and grit resistance), physical criteria (weight reduction so as to reduce energy consumption), optical criteria (sufficient light transmission in the visual range in order to guarantee appropriate visibility for driving the vehicle), or else thermal criteria (reduction in heat exchanges between the inside and the outside of the vehicle so as to reduce the use of heating or air-conditioning means).

Some of these criteria are contradictory. For example, a thin, and therefore lighter, laminated glazing unit makes it possible to reduce the consumption of fuel necessary for propulsion of the vehicle in which it is used. However, it has a lower projectile impact strength.

A first solution to this contradiction between the need to reduce the weight of laminated glasses and the need for mechanical impact strength is proposed in the prior art in the form of strengthened asymmetrical laminated glazing units.

A glazing unit is said to be asymmetrical when the thicknesses of the glass sheets that constitute it are different. In particular, in the case of asymmetrical laminated glazing units comprising two glass sheets assembled by means of an interlayer, one of the two glass sheets is a glass sheet referred to as “thin”. Its use makes it possible to reduce the weight of the glazing unit. Its thickness typically ranges between 0.4 mm and 1.5 mm.

An asymmetrical laminated glazing unit is said to be strengthened when at least one of the two glass sheets, generally the thinnest, is mechanically strengthened. The thin glass sheet is generally a sheet of glass of aluminosilicate type having undergone a mechanical strengthening treatment by chemical toughening; the other sheet of mineral glass, that is not strengthened, is generally a sheet of soda-lime-silica mineral glass.

An example of a strengthened asymmetrical laminated glazing unit is described in patent application US 2013295357 A (Corning Inc) Nov. 7, 2013. This glazing unit comprises a first sheet of soda-lime-silica mineral glass that has not been strengthened by chemical toughening and a second sheet of thin aluminosilicate or aluminoborosilicate mineral glass that has been strengthened by chemical toughening.

Another example of a strengthened asymmetrical laminated glazing unit is described in patent application WO 2017/103471 A (Saint-Gobain Glass France) Jun. 22, 2017. This glazing unit also comprises a soda-lime-silica glass sheet and a thin aluminosilicate glass sheet that has been strengthened by chemical toughening.

Chemical toughening is an ion-exchange process consisting of a superficial substitution of certain ions of a glass sheet by other ions of different nature and different size so as to generate compressive stresses at the surface of the glass sheet. These compressive stresses extend to a certain depth, termed compression depth. The chemical toughening of glasses and its effects are detailed in the article G Y, René. Ion Exchange for glass strengthening. Materials Science and Engineering B. 2008, Volume 149, p. 159-165.

Glasses of aluminosilicate or aluminoborosilicate type are, contrary to soda-lime-silica glasses, more suitable for strengthening treatment by chemical toughening. The physical reasons for this phenomenon are explained in the above-mentioned article. It is explained therein that, when a glass contains alkali metals and alumina in large amounts, the diffusion coefficients of the alkali metals are greater, and ion exchange during chemical toughening is promoted.

On the other hand, for soda-lime-silica glasses, conventionally used for the manufacture of symmetrical laminated glasses, the temperatures at which their viscoelastic relaxation occurs are too low compared with the temperatures at which the chemical toughening is carried out. Early viscoelastic relaxation leads to the loss of a significant portion of the benefit of mechanical strengthening subsequent to chemical toughening treatment. Furthermore, the presence of calcium in large amount in these glasses causes a considerable decrease in the ion-exchange rate.

The principal consequence of the inability of soda-lime-silica glasses to be chemically toughened is that they are not able to be used as a thin glass sheet for the manufacture of strengthened asymmetrical laminated glazing units for windshield applications. It is not possible to give them mechanical surface properties, in particular surface compressive stresses, so that the asymmetrical laminated glazing units can meet the technical criteria relating to the safety of individuals that are required by the national and international authorities for such applications.

Among the technical criteria required for laminated glazing units used as windshields, by the international legislations in force, two technical criteria can be mentioned by way of examples for the importance thereof:
the criterion relating to “head impact”, as described in paragraph 3.2 of annex 6, together with paragraph 3.1 of annex 3, of Regulation no 43 of the United Nations Economic Commission for Europe (UNECE) in force since Oct. 24, 2009;
the criterion relating to mechanical strength, as described in paragraph 4 of annex 6, together with paragraph 2.2 of annex 3, of Regulation n° 43 of the United Nations Economic Commission for Europe (UNECE) in force since Oct. 24, 2009.

### SUMMARY OF THE INVENTION

A subject of the invention is a laminated glazing unit comprising a first sheet of soda-lime-silica mineral glass having a thickness e1 of between 1.5 mm and 2.5 mm, a second sheet of mineral glass and a lamination interlayer, the first and second mineral glass sheets being adhesively bonded together by means of a lamination interlayer. The glazing unit is characterized in that:
the second mineral glass sheet is a sheet of soda-lime-silica mineral glass having a thickness e2 of between 0.4 and 1.1 mm, in particular between 0.4 and 0.7 mm;
said second sheet of soda-lime-silica mineral glass is chemically toughened;
the surface compressive strength of said second sheet of soda-lime-silica mineral glass is between 350 MPa and 550 MPa, in particular between 400 and 550 MPa;
the ratio R=e1/e2² is at most 20 mm⁻¹.

The invention also relates to a manufacturing process which makes it possible to obtain said laminated glazing unit.

### Technical Problem

The asymmetrical laminated glazing units comprising a chemically toughened aluminosilicate or aluminoborosilicate thin glass sheet have the advantage of having a high impact strength with respect to blunt objects. In windshield applications, the thin glass sheet of the asymmetrical glazing unit generally corresponds to the glass sheet placed on the inside of the vehicle passenger compartment. This configuration makes it possible to limit, in the event of an impact on the outer glass, the risk of breakage of the inner glass sheet and the projection of glass fragments into the passenger compartment that might injure its occupants.

Soda-lime-silica glasses are reputed to be unsuitable for the manufacture of asymmetrical laminated glazing units because it is not possible, in particular, to give them the appropriate surface mechanical properties. Thus, in a windshield, replacing the chemically toughened aluminosilicate or aluminoborosilicate inner thin glass sheet with a chemically toughened soda-lime-silica glass sheet increases the risk of breakage and projection of fragments into the passenger compartment.

However, asymmetrical laminated glazing units comprising a chemically toughened aluminosilicate or aluminoborosilicate thin glass sheet, as explicitly taught in patent application WO 2015/031151 A (Corning Inc) Mar. 5, 2015, do not comply with the criterion relating to “head impact” which requires that a glazing unit must break starting from a certain level of impact stress for reasons of the safety of individuals. The fracture stress under impact of asymmetrical laminated glazing units comprising a chemically toughened aluminosilicate or aluminoborosilicate thin glass sheet is too high to meet this criterion.

### Technical Solution

It has proven to be the case, against all expectations and surprisingly, that the use of soda-lime-silica glasses as thin glass sheet for the manufacture of asymmetrical laminated glazing units makes it possible to meet the criterion relating to “head impact”.

### BRIEF DESCRIPTION OF THE DRAWINGS

FIG. 1 is a schematic representation of a laminated glazing unit for a windshield application.

FIG. 2 is a graphic representation of the variation in number, expressed as percentage, of inner glass sheets of laminated glazing units broken under the impact of a spherical object as a function of the speed of impact of said object.

FIG. 3 is a graphic representation of the variation in number, expressed as percentage, of laminated glazing units chipped under the impact of a spherical object as a function of the speed of impact of said object.

### DESCRIPTION OF EMBODIMENTS

In the remainder of the text, reference is made to the figures in which the numbers relate to the elements described below.

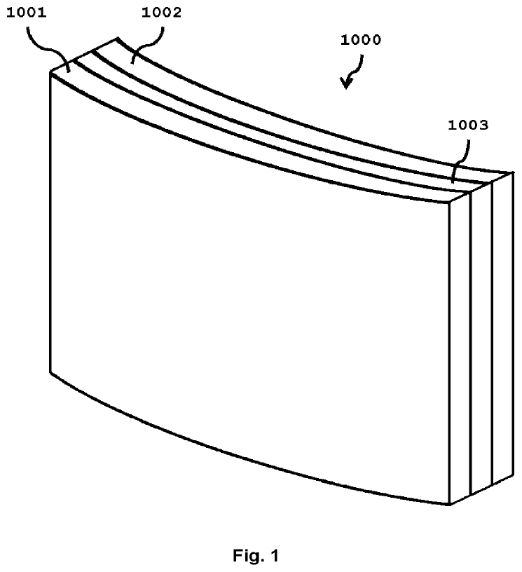

An example of a laminated glazing unit for a windshield application is represented in FIG. 1. The laminated glazing unit 1000 comprises a first glass sheet 1001, a second glass sheet 1002 and a lamination interlayer 1003. The two glass sheets 1001 and 1002 are adhesively bonded together by means of the lamination interlayer 1003. The glass sheet 1001 is termed external. It is positioned on the outside of the vehicle passenger compartment. The glass sheet 1002 is termed internal. It is positioned on the inside of the vehicle passenger compartment.

In an asymmetrical laminated glazing unit, the thicknesses of the glass sheets which constitute it are different. In the example in FIG. 1, the laminated glazing unit 1000 is asymmetrical if one of the two sheets, 1001 or 1002, is thinner than the other. In windshield applications, the thin glass sheet generally corresponds to the glass sheet 1002, that is to say the internal glass sheet, intended to be positioned inside the vehicle passenger compartment.

The laminated glazing unit of the invention comprises a first sheet of soda-lime-silica mineral glass having a thickness e1 of between 1.5 mm and 2.5 mm, a second sheet of mineral glass and a lamination interlayer, the first and second mineral glass sheets being adhesively bonded together by means of the lamination interlayer. The glazing unit is characterized in that:
the second mineral glass sheet is a sheet of soda-lime-silica mineral glass having a thickness e2 of between 0.4 and 1.1 mm, in particular between 0.4 and 0.7 mm;
said second sheet of soda-lime-silica mineral glass is chemically toughened;
the surface compressive stress of said second sheet of soda-lime-silica mineral glass is between 350 MPa and 550 MPa, in particular between 400 and 550 MPa;
the ratio R=e1/e2² is at most 20 mm⁻¹.

The laminated glazing unit according to the invention is suitable for use, for example, as a windshield, side window or roof glazing unit for land-based vehicles.

In particular, for the windshield applications, an advantage of the laminated glazing unit of the invention is that its weight is reduced compared with a non-asymmetrical laminated glazing unit. It also meets the abovementioned two criteria: the criterion relating to “head impact” and the criterion relating to mechanical strength.

In the laminated glazing unit of the invention, when the thin glass sheet is the internal glass sheet, the degree of breakage and of chipping of the inner glass sheet is less than 30%, or even 25%. Since the soda-lime-silica thin glass sheet is, all things being otherwise equal, mechanically less strong than an aluminosilicate or aluminoborosilicate thin glass sheet, the laminated glazing unit of the invention has a satisfactory mechanical behavior for the “head impact” criterion.

Another advantage of the laminated glazing unit of the invention is that the forming thereof can be simplified compared with an asymmetrical laminated glazing unit, the glass sheets of which have different chemical compositions, in particular compared with a laminated glazing unit comprising a soda-lime-silica glass sheet and an aluminosilicate or aluminoborosilicate thin glass sheet.

For certain applications in the motor vehicle field, a certain curvature is conferred on the glass sheets of the glazing unit before they are assembled. It is generally advantageous to use bending techniques or processes which allow the simultaneous forming of the glass sheets since the glass sheets thus have exactly the same curvatures. This makes them easier to assemble.

In bending processes or techniques, the two glass sheets are placed on top of one another and are supported substantially horizontally along their marginal end portions by a frame or skeleton having the definitive profile of the glazing unit after assembly. The thinnest glass sheet is positioned on the thicker glass sheet. The thin glass sheet pushes uniformly against the thicker glass sheet over the whole of the zones in contact. The two glass sheets are then placed in a bending furnace.

When the two glass sheets have different chemical compositions, for example in the case of a soda-lime-silica glass sheet and an aluminosilicate or aluminoborosilicate thin glass sheet, their thermal behaviors during bending are different because of the differences between the coefficients of expansion and the softening points. Consequently, the risk of occurrence of defects or residual stresses considerably increases. The laminated glazing unit of the invention makes it possible to reduce this risk.

For the purposes of the invention, the definitions of “surface compressive stress” and of “compression depth” are those indicated previously with reference to the abovementioned article.

The chemical toughening of the second sheet of soda-lime-silica glass can be carried out by dipping in a bath of molten salts between 400° C. and 500° C., in particular between 450° C. and 500° C., for a period of between 90 and 240 minutes, in particular between 90 minutes and 180 minutes. The bath of molten salts can be based on potassium nitrate or on a mixture of sodium nitrate and potassium nitrate.

If the surface compression depth obtained after chemical toughening of a glass sheet is greater than or equal to the thickness, or even half the thickness, of the glass sheet, the benefit of the treatment by chemical toughening for surface mechanical strengthening can be to a large extent lost. The smaller the thickness of the glass sheet, the more important the control of the surface compression depth may therefore be, in particular for thin glass sheets.

In one embodiment of the invention, the surface compression depth of the second sheet of soda-lime-silica mineral glass may be advantageously between 5 μm and 40 μm, in particular between 15 μm and 20 μm.

The thickness of the laminated glazing unit of the invention may be at most 5 mm, in particular 4.5 mm, or even 4 mm, without being detrimental to its mechanical performance levels.

The lamination interlayer placed between the two glass sheets may consist of one or more layers of thermoplastic material. Examples of thermoplastic material are polyurethane, polycarbonate, polyvinylbutyral (PVB), poly(methyl methacrylate) (PMMA), ethylene vinyl acetate (EA) or an ionomer resin.

The lamination interlayer may be in the form of a multilayer film. It may also have particular functionalities such as, for example, acoustic or else UV-stabilizing properties.

Typically, the lamination interlayer comprises at least one layer of PVB. Its thickness is between 50μ/τ/ and 4 mm. In general, it is less than 1 mm.

In the glazing units for vehicles, the thickness of the lamination interlayer is generally approximately 0.76 mm. When the constituent glass sheets of the laminated glazing unit are very thin, it may be advantageous to use a polymeric interlayer having a thickness of greater than 1 mm, or even greater than 2 or 3 mm. This makes it possible to confer stiffness on the laminated glazing unit, without being significantly detrimental to its weight.

In one embodiment of the invention, the lamination interlayer comprises at least one sheet of polyvinylacetal, in particular polyvinylbutyral.

In the lamination glazing unit of the invention, the thickness e2 of the second sheet of soda-lime-silica mineral glass is between 0.4 and 1.1 mm, in particular between 0.4 and 0.7 mm.

In one embodiment of the laminated glazing unit, the thickness e2 of the second sheet of soda-lime-silica mineral glass is advantageously at most 0.7 mm. Such a thickness contributes to decreasing the weight of the glazing unit.

Any soda-lime-silica glass composition can be suitable for the thin glass sheet of the laminated glazing unit of the invention. It can, in particular, comprise the following constituents in the limits defined below, expressed as weight fractions:

SiO₂ between 65.00 and 75.00%

Na₂O between 10.00 and 20.00%

CaO between 2.00 and 15.00%

Al₂O₃ between 0 and 5.00%

MgO between 0 and 5.00%

K₂O between 0 and 5.00%.

The first sheet of soda-lime-silica mineral glass of the glazing unit of the invention can be advantageously mechanically strengthened for certain applications. For an application of the laminated glazing unit of the invention as a windshield, the first sheet of soda-lime-silica mineral glass is preferably not mechanically strengthened.

The present invention also relates to a process for manufacturing a laminated glazing unit. The process comprises the following steps:

1. provision of a first sheet of soda-lime-silica mineral glass having a thickness e1 of between 1.5 mm and 2.5 mm;

2. a mechanical strengthening treatment by chemical toughening of a second sheet of soda-lime-silica mineral glass having a thickness e2 of between 0.4 and 1.1 mm, in particular between 0.4 and 0.7 mm, in a bath of molten salts between 400° C. and 500° C., in particular between 450° C. and 500° C., for a period of between 90 minutes and 240 minutes, in particular between 90 minutes and 180 minutes, the ratio R=e1/e2² being at most 20 mm⁻¹;

3. provision of a lamination interlayer;

4. assembly of the first and second glass sheets together by means of the lamination interlayer.

The bath of molten salts may be a bath based on sodium nitrate and/or potassium nitrate. Preferably, it is based on potassium nitrate.

The viscoelastic relaxation temperature of a soda-lime-silica glass can vary slightly with its chemical composition. A temperature that is too low compared with the temperatures at which the chemical toughening is carried out can bring about a loss of the benefit of mechanical strengthening subsequent to the chemical toughening treatment. The temperature of the bath of molten salts can be advantageously at most 490° C. This temperature is suitable for the majority of soda-lime-silica glass compositions.

The duration of the chemical toughening treatment can be adjusted according to the desired surface compression depth, the thickness of the thin glass sheet and the temperature of the bath of molten salts. As previously explained, if the surface compression depth obtained after chemical toughening of a glass sheet is greater than or equal to the thickness, or even half the thickness, of the glass sheet, the benefit of the chemical toughening treatment for the surface mechanical strengthening may be to a large extent lost.

In one embodiment of the invention, the duration of the mechanical strengthening treatment by chemical toughening can be advantageously at most 180 minutes. This duration makes it possible to limit the surface compression depth, in particular for thin glass sheets having a small thickness and high temperatures of the bath of molten salts.

It is possible to confer a curvature on the constituent glass sheets of the laminated glazing unit of the invention. For this, the manufacturing process of the invention can also comprise a step of bending the two sheets of soda-lime-silica mineral glass before step (1). The bending step can be carried out according to the usual bending processes and methods of the prior art that are suitable for soda-lime-silica glasses.

The laminated glazing unit of the invention can be used as a windshield, side window or else roof glazing unit for transportation vehicles. In this sense, the invention also relates to a glazing unit for a transportation vehicle, in particular motor vehicle, in particular a windshield, roof glazing unit or side window, comprising a laminated glazing unit according to any one of the embodiments of the invention.

For a windshield application, the second glass sheet can be the inner sheet, intended to be positioned on the inside of the passenger compartment of the vehicle. This configuration makes it possible to limit, in the event of an impact on the external face of the glazing unit, the risk of breakage of the inner glass sheet and the projection of glass fragments into the passenger compartment.

In one advantageous embodiment of the invention, the second sheet of soda-lime-silica mineral glass is chemically toughened on just one of its main faces. This makes it possible to simplify the chemical toughening treatment and to reduce the consumption of molten salts without being detrimental to the mechanical properties of the laminated glazing unit.

In particular, the second glass sheet can be strengthened on the face which is not in contact with the lamination interlayer. For example, in the case of a laminated glazing unit used in a windshield application, only the face oriented toward the inside of the passenger compartment of the vehicle may be chemically toughened.

The layer of surface compression the face of said second sheet of soda-lime-silica mineral glass which is not in contact with the lamination interlayer can then be between 5 μm and 40 μm, in particular between 15 μm and 20 μm.

In another embodiment of the invention, the face of the first glass sheet which is in contact with the lamination interlayer can comprise a functional coating having one or more layers. This coating can comprise at least one functional layer, optionally at least two or even three functional layers conferring on the laminated glazing unit functions termed “selective” making it possible to decrease the amount of energy transmitted through the glazing unit to the inside without being detrimental to the light transmission in the visible spectrum. The functional layers can be metal layers. In this case, they can be based on silver, gold and/or copper.

This functional coating can also comprise one or more dielectric assemblies of layers. A dielectric assembly of layers denotes one or more layers in contact with one another forming an overall dielectric stack, that is to say one which does not have the functions of a functional layer. Each dielectric assembly of layers generally comprises at least one layer based on a dielectric material which may be based on nitrides and/or based on oxides.

### Example

The advantages of the laminated glazing unit of the invention are illustrated by the example described below.

Two glazing units according to the invention were prepared. The first sheet of soda-lime-silica mineral glass has a thickness of 2.1 mm. The second sheet of mineral glass is a thin sheet of soda-lime-silica glass having a thickness of 0.7 mm and obtained by means of a float process. The lamination interlayer is an acoustic PVB film having a thickness of 0.85 mm.

Before the assembly of the laminated glazing unit, the thin mineral glass sheet was subjected to a mechanical strengthening treatment by chemical toughening. The treatment was carried out in a potassium nitrate bath at 490° C. for three hours.

The surface compression depth and surface compressive stress of the thin glass sheets, F1 and F2, of each glazing unit were measured by stratorefractometry according to the method described in the article G Y, René. Ion Exchange for glass strengthening. Materials Science and Engineering B. 2008, Volume 149, p. 159-165. The results are indicated in the table below. The surface compressive stresses are respectively 403 Mpa and 494 MPa, and the surface compression depths are respectively 18 and 17 μm.

TABLE 1

| | Stress | Depth |
|---|---|---|
| F1 | 403 MPa | 18 μm |
| F2 | 494 MPa | 17 μm |

A counter example laminated glazing unit was also prepared. It comprises a first sheet of soda-lime-silica mineral glass having a thickness of 2.1 mm and a thin second sheet of soda-lime-silica mineral glass having a thickness of 0.7 mm and obtained by means of a float process. The lamination interlayer is an acoustic PVB film having a thickness of 0.85 mm. Neither of the two sheets is chemically toughened.

Each glazing unit was the subject of a mechanical test according to the protocol described below. This mechanical test makes it possible to simulate the stresses to which a vehicle windshield is subjected under actual conditions. It makes it possible in particular to verify that the windshield meets the above-mentioned technical safety criteria. For the purposes of the mechanical test, the thin glass sheet is the inner glass sheet, intended to be positioned on the inside of the passenger compartment of the vehicle. The outer surface is the surface of the sheet of soda-lime-silica mineral glass intended to be placed on the outside of the passenger compartment of the vehicle.

The mechanical test is carried out according to the following protocol.

Four 300 mm×300 mm samples of each glazing unit are prepared.

The outer surface of each sample is evenly divided into nine zones. Each zone is subjected to an abrasion treatment for 5 seconds by rubbing under moderate pressure with an abrasive powder. The D50 value of the particle size distribution of the abrasive powder is between 10 and 40 μm. The abrasive powder consists predominantly of silica. At the end of the treatment, each zone is cleaned using a fabric soaked in a glazing unit cleaning agent.

A 1 g steel ball is then propelled and projected onto each of the zones with an angle of 45° relative to the surface and a speed ranging between 50 Km/h and 180 Km/h. There are thus nine impacts of the ball per sample, i.e. 36 impact measurements per glazing unit. The breakage and the chipping of the windshield are monitored by means of a high-frequency video camera.

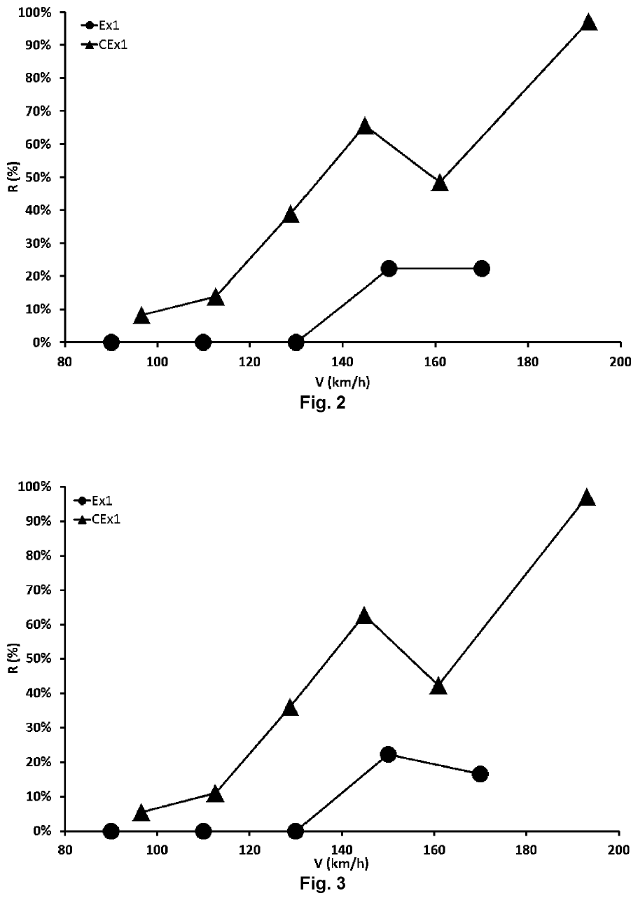

The results of the mechanical test are represented in FIG. 2 and FIG. 3.

FIG. 2 is a graphic representation of the variation in the number, expressed as a percentage, of inner glass sheets of laminated glazing units of the invention (circles) and of the counter example (triangles) broken under the impact of a spherical object as a function of the speed of impact of said object. The abscissas represent the speed of impact of the spherical object. The ordinates represent the degree of breakage. The degree of breakage is the number of zones broken over the total number of zones. In the figure, the round symbols represent the average values of the results for the two glazing units of the invention.

FIG. 3 is a graphical representation of the variation in the number, expressed as percentage, of laminated glazing units according to the invention (circles) and according to the counter example (triangles) chipped under the impact of a spherical object as a function of the speed of impact of said object. The abscissas represent the speed of impact of the spherical object. The ordinates represent the degree of chipping. The degree of chipping is the number of zones broken over the total number of zones. In the figure, the round symbols represent the average values of the results obtained for the two glazing units of the invention.

The figures show that, contrary to the laminated glazing unit of the counter example CEx1, the glazing unit Ex1 of the invention begins to break and to chip only starting from an impact speed of 130 Km/h. The degrees of breakage and of chipping of the glazing unit Ex1 are also two to three times lower than those of the counter example CEx1.

The example Ex1 of an asymmetrical laminated glazing unit of the invention is stronger than the glazing unit of the counter example CEx1. The fact that it begins to break and to chip starting from 130 Km/h makes it compliant with the “head impact” criterion.

1. A laminated glazing unit comprising a first sheet of soda-lime-silica mineral glass having a thickness e1 of between 1.5 mm and 2.5 mm, a second sheet of mineral glass and a lamination interlayer, the first and second mineral glass sheets being adhesively bonded together by the lamination interlayer, wherein:
the second mineral glass sheet is a sheet of soda-lime-silica mineral glass having a thickness e2 of between 0.4 and 1.1 mm;
said second sheet of soda-lime-silica mineral glass is chemically toughened;
a surface compressive stress of said second sheet of soda-lime-silica mineral glass is between 350 MPa and 550 MPa;
ratio R=e1/e2² is at most 20 mm⁻¹.

2. The laminated glazing unit as claimed in claim 1, wherein a surface compression layer depth of said second sheet of soda-lime-silica mineral glass is between 5 μm and 40 μm.

3. The laminated glazing unit as claimed in claim 1, wherein a thickness of the laminated glazing unit is at most 5 mm.

4. The laminated glazing unit as claimed in claim 1, wherein the thickness e1 of the second sheet of soda-lime-silica mineral glass is at most 0.7 mm.

5. The laminated glazing unit as claimed in claim 1, wherein the lamination interlayer comprises at least one sheet of polyvinylacetal.

6. The laminated glazing unit as claimed in claim 1, wherein the second sheet of soda-lime-silica mineral glass comprises the following constituents in the limits defined below, expressed as weight fractions:
SiO₂ between 65.00 and 75.00%
Na₂O between 10.00 and 20.00%
CaO between 2.00 and 15.00%
Al₂O₃ between 0 and 5.00%
MgO between 0 and 5.00%
K₂O between 0 and 5.00%.

7. The laminated glazing unit as claimed in claim 1, wherein the first sheet of soda-lime-silica mineral glass is not mechanically strengthened.

8. The laminated glazing unit as claimed in claim 1, wherein the second sheet of soda-lime-silica mineral glass is chemically toughened on just one of its principal faces.

9. The laminated glazing unit as claimed in claim 7, wherein the strengthened principal face is not in contact with the lamination interlayer.

10. The laminated glazing unit as claimed in claim 1, wherein the face of the first sheet of soda-lime-silica mineral glass in contact with the lamination interlayer comprises on its surface a functional coating comprising one or more layers.

11. A process for manufacturing a laminated glazing unit as claimed in claim 1, said process comprising:
providing a first sheet of soda-lime-silica mineral glass having a thickness e1 of between 1.5 mm and 2.5 mm;
performing a mechanical strengthening treatment by chemical toughening of a second sheet of soda-lime-silica mineral glass having a thickness e2 of between 0.4 and 1.1 mm in a bath of molten salts between 400° C. and 500° C. for a period of between 90 minutes and 240 minutes, the ratio R=e1/e2² being at most 20 mm⁻¹;
providing a lamination interlayer, and
assembling the first and second glass sheet together by the lamination interlayer.

12. The process for manufacturing a laminated glazing unit as claimed in claim 11, wherein the bath of molten salts is a bath based on potassium nitrate.

13. The process for manufacturing a laminated glazing unit as claimed in claim 10, wherein the temperature of the bath of molten salts is at most 490° C.

14. The process for manufacturing a laminated glazing unit as claimed in claim 10, wherein a duration of the mechanical strengthening treatment by chemical toughening is at most 180 minutes.

15. The process for manufacturing a laminated glazing unit as claimed in claim 10, further comprising bending the first and second sheets of soda-lime-silica mineral glass before performing the mechanical strengthening treatment.

16. A glazing unit for a transportation vehicle, comprising a laminated glazing unit as claimed in claim 1.

17. The glazing unit as claimed in claim 16, wherein the second glass sheet is the inner sheet, intended to be positioned on the inside of the passenger compartment of the vehicle.

18. The laminated glazing unit as claimed in claim 1, wherein the thickness e2 is between 0.4 and 0.7 mm and the surface compressive stress of said second sheet of soda-lime-silica mineral glass is between 400 and 550 MPa.

19. The laminated glazing unit as claimed in claim 2, wherein the surface compression layer depth of said second sheet of soda-lime-silica mineral glass is between 15 μm and 20 μm.

20. The laminated glazing unit as claimed in claim 3, wherein the thickness of the laminated glazing unit is at most 4 mm.
